(19) United States
(12) Patent Application Publication
(10) Pub. No.: US 2017/0228655 A1
(43) Pub. Date: Aug. 10, 2017

(54) DECISION MAKING PLATFORM

(71) Applicant: Blue J Legal Inc., Toronto (CA)

(72) Inventors: Benjamin Alarie, Toronto (CA); Brett Janssen, Toronto (CA); Anthony Niblett, Toronto (CA); Albert Yoon, Toronto (CA)

(21) Appl. No.: 15/428,532

(22) Filed: Feb. 9, 2017

Related U.S. Application Data
(60) Provisional application No. 62/293,183, filed on Feb. 9, 2016.

(51) Int. Cl. G06N 5/04

(52) U.S. Cl. CPC G06N 5/047; G06N 5/048

(57) ABSTRACT

Provided herein are methods and systems for defining an outcome of interest and receiving a plurality of input that may be analyzed to determine a set of fact patterns that are present within or implied by the input. The Decision Making Platform described herein may be used to calculate a degree of association between each of a plurality of fact patterns and a specified outcome of interest. A user of the Decision Making Platform may input data, such as that pertaining to the user's circumstances or facts relating to the user, for analysis. The user input may be analyzed to determine the association of the user's data with the specified outcome of interest based at least in part on the plurality of input and associated fact patterns, and associations with the outcome of interest, within a corpus of data that is stored by the Decision Making Platform.

### CLAIM TO PRIORITY

This application claims the benefit of the following United States Provisional Application, which is hereby incorporated by reference in its entirety: U.S. Patent Application Ser. No. 62/293,183, filed Feb. 9,2016 (Attorney Docket No. BLUJ-0001-P01).

### FIELD OF THE INVENTION

The disclosure generally relates to methods and systems for determining decision options and outcomes based at least in part on real time, automated semantic analysis, categorization and rules-based processing of text-, audio-, and multi-media-based source material, wherein frequently changing data inputs may be used to create and continually update a corpus of fact patterns that may be utilized to test decision making options, trends, patterns, and expected outcomes, and generate alerts, machine instructions and the like upon the occurrence of specified events and occurrences.

### BACKGROUND OF THE INVENTION

Current decision making aids for making legal categorizations, advice as regards the need for litigation, gauging one's likelihood of prevailing in a suit against an adverse party or a regulatory compliance outcome, and the like tend to be dominated by service professionals with a specialized skill, such as lawyers and tax professionals. In spite of having specialized knowledge in an area, such professionals may suffer from numerous forms of bias and/or base their decision making on outdated experiential references, texts, and decision making frameworks. Such professionals are also often expensive and therefore inaccessible to some for financial reasons. Therefore there is a need for non-human based decision making aids that may ingest the vast amount of public and private data, analyze such data, and create recommendations based at least in part on users' unique data inputs regarding circumstances and facts, and specified outcomes that may be associated with those circumstances and facts.

### SUMMARY

Provided herein are methods and systems for defining an outcome of interest and receiving a plurality of inputs, including but not limited to text, audio or multimedia, that may be analyzed to determine a set of fact patterns that are present within or implied by the inputs. The Decision Making Platform described herein may be used to calculate a degree of association between each of a plurality of fact patterns and a specified outcome of interest. A user of the Decision Making Platform may input data, such as that pertaining to the user's circumstances or facts relating to the user, for analysis. The user input may be analyzed to determine the association of the user's data with the specified outcome of interest based at least in part on the plurality of inputs and associated fact patterns, and associations with the outcome of interest, within a corpus of data that is stored by the Decision Making Platform. A report may then be generated to the user, such as on a remote client device, wherein the report includes at least in part a summary of the degree of association of the user fact patterns with the outcome of interest based on the comparison of the user fact patterns with the plurality of fact patterns. In embodiments the summary within the report may be ranked based at least in part on the strength of the degree of association. A “user” may comprise a plurality of users, and the plurality of users' inputs may be analyzed in the aggregate.

In embodiments, an outcome of interest and receiving a plurality of inputs, including but not limited to text, audio or multimedia, that may be analyzed to determine a set of fact patterns that are present within or implied by the inputs. The Decision Making Platform described herein may be used to calculate a degree of association between each of a plurality of fact patterns and a specified outcome of interest. A user of the Decision Making Platform may input data, such as that pertaining to the user's circumstances or facts relating to the user, for analysis. The user input may be analyzed to determine the association of the user's data with the specified outcome of interest based at least in part on the plurality of inputs and associated fact patterns, and associations with the outcome of interest, within a corpus of data that is stored by the Decision Making Platform. As data is added to the corpus of the plurality of input to the Decision Making Platform and/or the user data inputs are changed, augmented or altered in some manner, the Decision Making Platform may incorporate the new input into the plurality of inputs to create an updated plurality of input. The updated plurality of inputs may be analyzed to determine a second plurality of fact patterns that are associated with the outcome of interest and a second degree of association between each of the second plurality of fact patterns to the outcome of interest may be calculated. Each user fact pattern may be compared among the plurality of user fact patterns with the second plurality of fact patterns. The Decision Making Platform may detect a change in a degree of association of at least one of the user fact patterns based on the degree of association with the second plurality of fact patterns relative to the degree of association with the first plurality of fact patterns, and present a report to the user on a remote client device, wherein the report includes at least in part a summary of the detected change in the degree of association of the user fact patterns to the outcome of interest. In embodiments, the report may be the generated if the detected change meets or exceeds a threshold level of change specified by the user, the detected change meets or exceeds a threshold level of change that is statistically significant, and/or if the detected change meets or exceeds a threshold level of change that alters the probable outcome of interest relative to that determine in a prior report for the user. In embodiments the presentation of the report may be in association with an alert that is sent to the user's remote client device.

In embodiments, the alert may be transmitted over a communication channel to a remote client device associated with the user based upon a destination address and transmission schedule that is associated with the remote client device.

In embodiments, the alert may activate a graphical user interface to cause the alert to display on a remote client device and to enable connection with the graphical user interface when the remote client device is activated.

In embodiments, the analysis of input may be based at least in part on semantic analysis and/or voice recognition.

In embodiments, an outcome of interest may be a categorization, such as a taxation categorization criterion.

In embodiments, a degree of association may be a numeric probability, including a conditional probability, including where the conditional probability is conditional on the entirety of a plurality of fact patterns or a subset of a plurality of fact patterns.

In embodiments, a degree of association may be a binary categorization and/or a plurality of categories.

In embodiments, the input may be text. Text may include, but is not limited to, a court decision, an administrative decision, a regulatory guidance, a regulation, a law, a news release, a professional white paper, a journal article, an RSS feed, text derived from webcrawling, text derived from a third party database, or some other text source. In embodiments, the input may be audio and/or multimedia.

In embodiments, an outcome of interest may be defined within the Decision Making Platform, which receives a plurality of inputs and analyzes the plurality of inputs to determine a plurality of fact patterns that are associated with the outcome of interest. The Decision Making Platform may calculate a degree of association between each of the plurality of fact patterns to the outcome of interest and rank each fact pattern among the plurality of fact patterns according to the degree of association. The Decision Making Platform may then present a ranked report to a user on a remote client device, wherein the report includes at least in part a subset of the plurality of fact patterns bearing the strongest degree of association with the outcome of interest. In embodiments, the presented ranked report may identify at least one fact pattern among the fact pattern that is necessary to maintain a degree of association with the outcome of interest above a specified threshold. A specified threshold may be specified by a user and/or by a level of statistical significance. In embodiments, the presented ranked report may identify at least one fact pattern among the fact pattern that is necessary to maintain a degree of association with the outcome of interest above a specified threshold, and which is missing from a user's set of fact patterns. In embodiments, the presented ranked report may identify at least one combination of fact patterns among the fact pattern that is necessary to maintain a degree of association with the outcome of interest above a specified threshold. In embodiments, the presented ranked report may identify at least one fact pattern among the fact pattern that is necessary to maintain a degree of association with the outcome of interest above a specified threshold.

In embodiments, an outcome of interest may be defined within the Decision Making Platform, which receives a plurality of inputs and analyzes the plurality of inputs to determine a plurality of fact patterns that are associated with the outcome of interest. The Decision Making Platform may calculate a degree of association between each of the plurality of fact patterns to the outcome of interest. The Decision Making Platform may receive a first user input, wherein the first user input is provided through a graphical user interface that is associated with a remote client device, and analyze the first user input to determine a plurality of first user fact patterns. The Decision Making Platform may calculate a probability of the first user fact pattern yielding the outcome of interest based at least in part on a comparison with the plurality of fact patterns. The Decision Making Platform may receive a second user input and analyze the second user input to determine a plurality of second user fact patterns, and calculate a conditional probability of the first user fact pattern yielding the outcome of interest based at least in part on a comparison with the plurality of fact patterns and comparison with the second user fact patterns. The Decision Making Platform may then present a report to the user on the remote client device, wherein the report includes at least in part the conditional probability. In embodiments, a first remote client device and a second remote client device may be a common remote client device.

In embodiments, an outcome of interest may be defined within the Decision Making Platform, which receives a plurality of inputs and analyzes the plurality of inputs to determine a plurality of fact patterns that are associated with the outcome of interest. The Decision Making Platform may calculate a degree of association between each of the plurality of fact patterns to the outcome of interest. The Decision Making Platform may receive a first user input, wherein the first user input is provided through a graphical user interface that is associated with a remote client device, and analyze the first user input to determine a plurality of first user fact patterns. The Decision Making Platform may calculate a probability of the first user fact pattern yielding the outcome of interest based at least in part on a comparison with the plurality of fact patterns. The Decision Making Platform may receive a second user input and analyze the second user input to determine a plurality of second user fact patterns, and calculate a conditional probability of the first user fact pattern yielding the outcome of interest based at least in part on a comparison with the plurality of fact patterns and comparison with the second user fact patterns, and calculate a divergence measure, wherein the divergence measure expresses the degree of separation between the first probability and the second probability. The Decision Making Platform may then present a report to the user on the remote client device, wherein the report includes at least in part the divergence measure. In embodiments, a first remote client device and a second remote client device may be a common remote client device.

These and other systems, methods, objects, features, and advantages of the present disclosure will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

Particulars and variations of the above embodiments along with other embodiments will be described below.

### BRIEF DESCRIPTION OF THE DRAWINGS

The disclosure and the following detailed description of certain embodiments thereof may be understood by reference to the following figures:

FIG. 1A illustrates a simplified view of the Decision Making Platform in association with a user, administrator, analytic engine and email generation.

FIG. 1B illustrates a simplified view of components of the Decision Making Platform for the intake, analysis of data inputs and the reporting of results and recommendations.

FIG. 2 illustrates a flow diagram for general processing steps in determining worker and residency classifiers using the Decision Making Platform.

FIG. 3 illustrates a high-level component/integration model of the Decision Making Platform.

FIG. 4 illustrates a hypothetical question flow for determining a worker-residency status for an individual using the Decision Making Platform.

FIG. 5 illustrates a hypothetical “Ask” question service flow using the Decision Making Platform.

### DETAILED DESCRIPTION

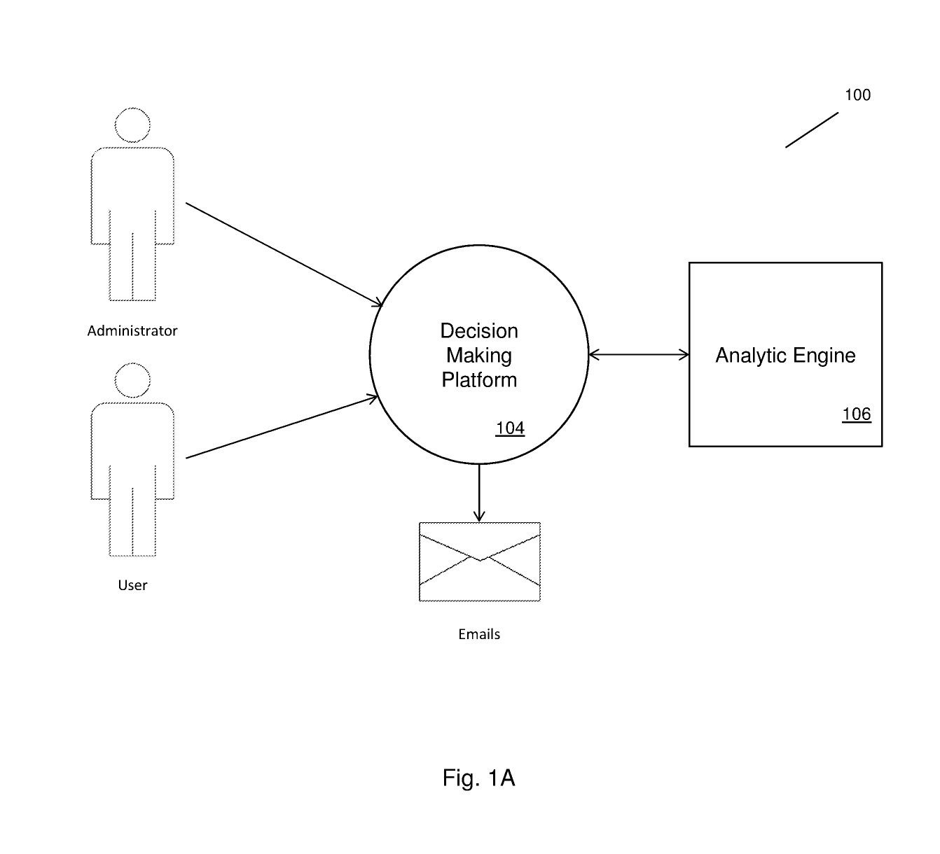

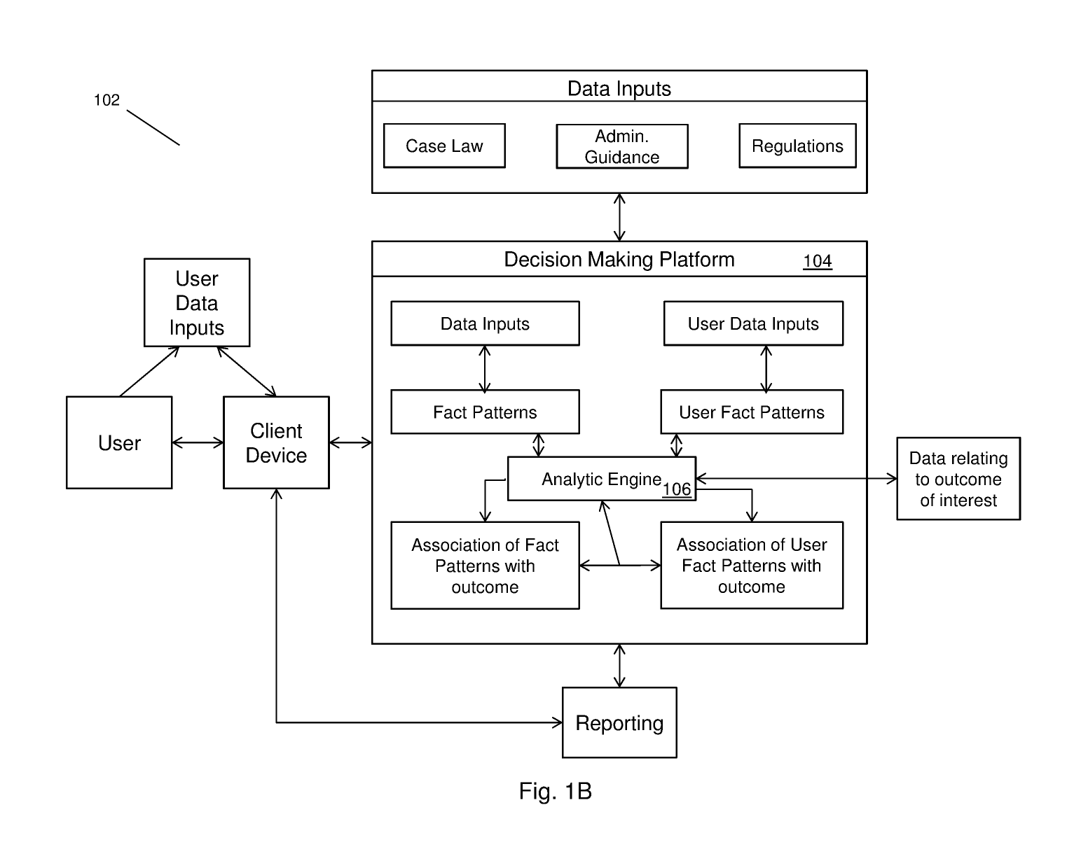

In embodiments of the present disclosure, as depicted in FIGS. 1A and 1B, the methods and systems of the Decision Making Platform 104 disclosed herein may include, but are not limited to, an analytic engine 106 that may 1) receive, store and distribute data inputs, including but not limited to visual, text, audio, multimedia, or some other type of input, 2) analyze and detect patterns within the data inputs, 3) determine the degree of association(s) of the plurality of detected patterns with a specified outcome of interest, 4) determine the type and amount of information needed to calculate the probabilities of the occurrence of the specified outcome that are associated with detected patterns with data inputs, and 5) report summaries, recommendations, analyses and other types of information to a user for the purposes of assisting the user's decision making as regards at least the outcome of interest, given a fact pattern used as a data input to the Decision Making Platform 104. Analytic engine, as used herein, may refer to an analytic facility that is within the Decision Making Platform 104 and/or an analytic facility that is associated, or in communication with the Decision Making Platform 104.

The terms “strong,” “strongest,” and similar descriptions, when referencing a degree of association as utilized herein should be understood broadly. A strongest degree of association includes, without limitation, an association wherein a factor, variable, and/or other criteria comprise: a quantitatively greatest factor in an estimated outcome; that contribute a quantitatively greatest confidence contribution to an estimated outcome; that have a quantitatively greatest sensitivity contribution to an estimated outcome (e.g. a given change amount in the factors determining the strongest degree of association results in a greater change in the estimated outcome than one or more other factors); that, within a range of reasonable, pre-determined, or expected potential change values for the factor, exhibit a greatest range of effects (qualitative or quantitative) on the estimated outcome (e.g. another factor may be present that contributes more strongly to the estimated outcome, but is not expected to change as much as the “strongest” factor); and/or that is determinative to a qualitative outcome for the estimated outcome (e.g. a threshold defined in a regulation, and/or a pass/fail criteria).

The term “degree of association,” as utilized herein should be understood broadly. A degree of association includes, without limitation, a determined or estimated amount of association wherein a factor, variable, and/or other criteria comprise: a quantitative effect on the estimated outcome; a quantitatively effect on a confidence contribution to an estimated outcome; a quantitative effect on a sensitivity contribution to an estimated; a range of effects (qualitative or quantitative) on the estimated outcome associated with a range of reasonable, pre-determined, or expected potential change values for the factor; and/or that a degree of determination of a qualitative outcome for the estimated outcome in response to the factor, variable, and/or other criteria (e.g. a threshold defined in a regulation, and/or a pass/fail criteria).

As an example embodiment of the present disclosure, the Decision Making Platform 104 may read or ingest textual data inputs, including case law, court opinions, administrative guidance, legislation, regulations, professional commentary, academic publications, news releases, free form text entry, and the like to assist professional judgment, including but not limited to, tax and legal matters. In addition to guiding decision making, the Decision Making Platform 104 may provide answers to submitted questions, based at least in part on the corpus of materials, derived from a plurality of data inputs, on which the Decision Making Platform 104 is based. In embodiments, the Decision Making Platform 104 may include machine learning that is powered by an analytic engine 106 to provide an independent complement to professional judgment, such as that used by administrators, corporate executives, tax accountants and lawyers. For example, a user utilizing the Decision Making Platform 104 for tax-related questions may provide the Platform factual inputs regarding a type of income, the time of receipt, or some other type of information. Based on this information, the Decision Making Platform 104 can determine whether the income is considered a “capital gain” for the purposes of taxation. Other classifiers may include, but are not limited to, residency classifiers, worker classifiers, home office classifiers, capital expense classifiers, real estate classifiers, or some other type of classifier. A residency classifier may be used to designate if a person qualifies as a resident of a jurisdiction, such as a country or economic union, such as for tax purposes. A worker classifier may be to categorize if a worker is an employee or an independent contractor. A home office classifier may be used to designate if expenses related to a work space in the home can be deducted for tax purposes. A capital expense classifier may be used to determine whether an expenditure is a current expense or a capital expenditure for tax purposes. A real estate classifier may be used to determine if gains on the sale of real estate are income from business or capital gains.

The functionalities of the Decision Making Platform 104 may include, but are not limited to:

Login capability (with both authentication and authorization capability);

User self-management (e.g. password management);

Feedback results;

Basic configuration page (accessed by administration rights);

All code and packaging/deployment scripts; and

Deployment into two environments (production and test) using Heroku.

User administration (e.g. adding/removing users, etc.);

Caching of known responses, response changes, updates, additions, deletions and the like;

Payment management;

Reporting; and

Analytics.

In embodiments, services provided by the Decision Making Platform 104 may utilize an analytic engine 106 as a back end service provider (additional machine learning engines, facilities, services, and/or providers may also be added). Further, the Decision Making Platform 104 may be utilized via a web site, or other digital service interface, and used as a “front end” to the decision making services and for training the analytic engine 106.

In embodiments, the Decision Making Platform 104 may provide services to various user types, including, but not limited to the following:

Administrator—this user type may have access to everything, including the system configuration page and including disabled services

User—this user type may have access to each of the enabled services provided in the Decision Making Platform 104.

In a sample embodiment of the present disclosure, the Decision Making Platform 104 may receive a defined outcome of interest. As an example, an outcome of interest may be conformance with a categorization, such as “employee” or “independent contractor.” Other examples of outcomes may be a threshold (e.g., “damages award in excess of $75,000), an action (e.g., “change of venue for litigation”), an indication of having sufficient information (e.g., “financial data submitted sufficient for rendering judgment on capital gains status”), or some other type of outcome of interest. Continuing the example, the Decision Making Platform 104 may receive a plurality of input used to form a decision making corpus for use by the Decision Making Platform 104 to calculate degrees of association between fact patterns within the corpus of information and specified outcomes of interest. The plurality of input may include text, audio or some other type of data as input. The input data may derive from data entered directly by a user, such as that typed into a text field that is associated with the Decision Making Platform 104, documents submitted by the user, numeric data, spreadsheets, press releases, audio data (e.g., from a court proceeding, news segment, deposition, corporate proceeding, conference or some other type of audio data). Using the analytic techniques described herein, including but not limited to machine learning, the data inputs may be analyzed to detect fact patterns. Fact patterns may be related to persons, entities (e.g., government or corporate), locations, events and sequences of events (e.g., hire date, Salary 1, Event 1, Salary 2, termination of employment date), or some other type of fact pattern. Fact patterns may be analyzed to calculate a degree of association with a specified outcome of interest.

In embodiments, data inputs to the Decision Making Platform 104 may be analyzed based at least in part on semantic analysis, voice recognition, or some other analytic technique.

In embodiments, a degree of association calculated by the Decision Making Platform 104, such as that between a fact pattern within a corpus of information, as described herein, and a specified outcome of interest, may be expressed as a probability, a categorization (e.g., a binary categorization), a conditional probability, including but not limited to a conditional probability that is conditional on the entirety and/or a plurality of fact patterns with a corpus of information.

In a simplified example, a specified outcome of interest may be categorizing a person as either an “employee” of a company or as an “independent contractor” of a company. A plurality of data inputs used to build the corpus of information related to this outcome of interest may include, administrative hearings, tax court decisions, regulatory briefs, press releases and guidance from tax offices, advice from tax preparation entities, or some other kind of information. A user, such as a business officer may want to use the Decision Making Platform 104 to help determine if a worker being used on a project is best categorized as an employee or independent contractor for tax purposes. There might be a limited set of data available regarding the worker, such as age, gender, date of hire, number of hours worked, location of work, and so forth. The Decision Making Platform 104 may calculate the degree of association of each of these fact patterns with the specified outcome of interest based on the knowledge inherent within, and learned from, the corpus of information stored by the Platform. Continuing this example, the Decision Making Platform 104 may calculate a low degree of association for the fact pattern “age of person,” but a high degree of association with the fact patterns “number of hours worked” and “duration of employment.” Using this data, the Decision Making Platform 104 may present to the user a report and summary indicating that there is a high probability that the worker is an employee based on the hours worked and duration of employment. In an alternate example, if the user only had data inputs into the Decision Making Platform 104 relating to the age and gender of the worker, the Platform may present to the user an indication that the data inputs provided are not sufficient to reach a determination on the outcome of interest, or the Platform may indicate that a categorization based on the data inputs provided by the user has a low probability of accurately categorizing the worker as either an employee or independent contractor. In addition, based on the known associations between the fact patterns found in the corpus and the outcome of interest, the Decision Making Platform 104 may rank the fact patterns within the corpus according to these associations and present to the user, for example, the top 10 fact patterns bearing the strongest relationships with making the “employee” versus “independent contractor” distinction. This may help guide the user in collecting the additional information to use as new data inputs that are most likely to assist in making the outcome determination that is sought.

The Decision Making Platform 104 may include, but is not limited to, product and service features such as:

Worker classification (e.g., independent contractor or employee)

Residency classification (e.g., resident, non-resident, resident alien, non-resident alien)

Tangible expenditure classification (e.g., classification of tangible property)

Intangible expenditure classification (e.g., classification of intangible property)

Real estate classification (e.g., characterizing the sale of real estate as income or capital)

Securities trading classification (e.g., characterizing the sale from securities trading as income or capital)

Taxable benefits classification (e.g., whether benefits received from work are taxable)

Home office classification (e.g., whether expenses related to work space in the home are deductible)

Carrying on business classification (e.g., whether the operations of a non-resident enterprise constitute carrying on business for the Income Tax Act and Excise Tax Act)

Response to users' tax law questions

The worker, residency, tangible expenditure, intangible expenditure, real estate, securities trading, taxable benefits, and home office classification services may be tailored services where a user is prompted to answer a number of questions about their specific scenario. The answers to these questions may be used as input to the analytic engine 106, which may determine a classification based on those answers.

In embodiments, the corpus of information input to the Decision Making Platform 104 may be continually updated to include new information. For example, continuing the employee versus independent contractor example, it might be the case that there is an imminent change in political authority following an election. Based on press releases and other data input into the system, there may be a growing body of text or other data in the corpus indicating that there is a statistically significant probability that the new administration will seek to change tax law in a manner that impacts how a worker is designated as an employee or independent contractor. This update to the corpus and the potential or actual change in the degree of associations between the facts previously input by a user may cause an alert to be sent to the user, where the alert includes at least in part a notice that there might be an imminent change in the tax code impacting one of the user's workers that was the subject of a prior review. This alert may be transmitted over a communication channel to a remote client device associated with the user based upon a destination address and transmission schedule that is associated with the remote client device. The alert may activate a graphical user interface to cause the alert to display on the remote client device and to enable connection with the graphical user interface when the remote client device is activated. The alert may cause the remote client device to awaken from a “sleep mode” or other type of inactive mode and/or transition from a state of being disconnected from a network, such as to the Internet, VPN or some other network type, to a connected state. Similarly, a corpus that is stored and used by the Decision Making Platform 104 may be continually updated to account for changes in case law, administrative directives or any other type of data input used by the corpus. A change, detected change, and the like as the terms are used herein may refer to an anticipated change, such as that associated with a changing political administration, effective date, regulatory reform, or some other future event that might impact an outcome of interest. A level of change that triggers a report, alert or some other type of notifying action may be set by a user or by the Decision Making Platform 104. For example, the Decision Making Platform 104 may have data regarding the user's past behavior from which the Platform may derive a level of change that is of interest to the user. In certain embodiments and without limitation, the level of change that is of interest to the user includes an incrementally improved level of change and/or an optimized level of change estimated to improve the probability that a user will have interest in the report, alert, or other type of notifying action. Alternatively, the Platform 104 may have data from a plurality of users from which a level of change that is of interest to the user may be identified, for example, based at least in part on some shared characteristic between the user and the plurality of users. In another example, a change in the outcome of interest may be used to adjust the level of change utilized in order to generate a report alert or other type of notifying action.

In another example, the responses to tax law questions may allow a user to type any question as an input to the Decision Making Platform 104. This input may then be used as input to a different, more generic analytic engine 106 service. The user may then be presented with a list of answers that the analytic engine 106 deemed relevant based on what it could find, utilizing the materials reviewed by the analytic engine 106 (e.g., tax law cases). The materials utilized by the analytic engine 106 may be curated to conform to an analytic purpose. In embodiments, the analytic engine 106 may be a super computer, artificial intelligence, including but not limited to IBM Watson, Google DeepMind, Microsoft Azure, or some other type of analytic engine 106. Analytic results, recommendations, requests for additional information and the like may be presented to users and or administrations of the Decision Making Platform 104 via email, GUI, web interface, API or some other means, as illustrated in the overview FIG. 1A.

In embodiments, the Decision Making Platform 104 may provide a monitoring and alerting functionality for users. In an example, the corpus of materials on which the Decision Making Platform 104 is based may be monitored for changes over time, and areas of change may be flagged or otherwise noted and stored within the system as variable elements. For example, within tax laws and codes there may be doctrines, principles, interpretations or other facets of the law that are subject to ongoing judicial interpretation, clarification, or change, and/or data relating to a user of the Platform that is subject to change. Continuing the example, it might be the case that the handling of foreign income for tax purposes is subject to a threshold, below which the user-taxpayer need not report such income. The user may allow the Decision Making Platform 104 to monitor her financial accounts or the user might simply note, over time, the amount of foreign income received. As the monitoring occurs, because the Decision Making Platform 104 has artificial intelligence regarding the reporting of foreign income as regards tax laws, once the user reaches or exceeds the threshold that requires reporting for tax purposes, an alert may be sent to the user by the Decision Making Platform 104. This alert may be a text, email, phone call, ground mail notification, or some other type of communication means. The alert may instead, or also, send the alert to a party specified by the user to be notified, such as an accountant. The alert might be a notice instead, for example, alerting the user that if she receives a certain dollar amount of additional foreign income she will be subject to taxation, but if she were able to delay receipt of such payment until the next calendar year she might be able to defer some taxation.

In embodiments, services provided by the Decision Making Platform 104 may utilize an analytic engine 106 as a back end service provider (additional machine learning engines, facilities, services, and/or providers may also be added). Further, the Decision Making Platform 104 may be utilized via a web site, or other digital service interface, and used as a “front end” to the decision making services and for training the analytic engine 106.

In another example, it might be the case that the variable element is changes to tax law itself. In this example, it might be the case that the courts' interpretation of “foreign income” is subject to change. The Decision Making Platform 104 may be able to recognize this facet of the case law as a variable element and monitor the law to detect a change that has a material impact for a user. Continuing this hypothetical example, if the judicial holdings establish that the definition of foreign income, say, now has changed to exclude a type of income (e.g., income derived from work for foreign charitable organizations), an alert may be sent to a user that has indicated to the Decision Making Platform 104 that at least a portion of her income derives from work for foreign charitable organizations. This artificial intelligence advisory role of the Decision Making Platform 104 may allow users to continuous monitor aspects of law or other areas passively.

In embodiments, the Decision Making Platform 104 may be used as a compliance tool for the purpose of determining the factors, variables and other criteria that bear the strongest degree of association with an outcome of interest.

As described herein, the Decision Making Platform 104 may receive a plurality of inputs, such as text and/or audio, and determine the degree of association that each fact pattern inherent in the inputs has with a specified outcome of interest. Presenting the results of this analysis, in a ranked ordering according to the strength of association, may guide a user in determining the most salient facts that are determinative of the outcome of interest. In an example, a user may want to know the most important factors used to determine if a person qualifies as a Canadian resident. The Decision Making Platform 104 may have received, analyzed and stored a plurality of inputs related to Canadian residency rules and requirements. Inputs of relevance may include, but are not limited to court decisions, government regulations, government memoranda, each of which may include fact patterns that may be analyzed to determine a degree of association with being classified as a Canadian resident. Fact patterns may include, but are not limited to, country of origin, date of arrival, occupation, earnings, revenue, or some other factor. The Decision Making Platform 104 may present a user a ranking of such fact patterns to indicate which of the factors are most important for the user to consider. This may aide the user in focusing only on those elements that are most likely to influence the residency determination. By being able to rule out collecting information that might be of limited value to making the residency determination, resources may be saved. This may also assist the user in identifying missing information that they will likely need in order to make a sufficient case on residency status. In another embodiment, the user may be able to input the data that they have available relating to an individual's residency determination, and the Decision Making Platform 104 may assess the sufficiency of the information available to the user based at least in part on a comparison of the user's data input and the fact patterns stored and ranked by the Decision Making Platform 104. If more information is needed by the user before a residency determination can be made, knowing that prior to beginning the formal process for determining residency may be valuable.

In embodiments, the Decision Making Platform 104 may also identify necessary fact patterns that must be present in order for there to be a statistically significant likelihood of a specified outcome occurring. For example, if a worker is using the Decision Making Platform 104 to determine the factors that impact her ability to maintain a specified level of health insurance coverage (e.g., the specified outcome is “eligible for healthcare coverage”), it might be the case that there is a requirement by the employer that a certain number of hours are worked per pay period in order to qualify for coverage. Thus, even though other fact patterns present in the worker's data inputs to the Decision Making Platform 104 may bear a degree of association with the outcome of interest, the specified number of hours worked per pay period would be a necessary fact pattern (i.e., if the number of hours worked is less than this amount, all other fact patterns are immaterial). In another example, the Decision Making Platform 104 may inform a user in a report or other output of a necessary fact or pattern of facts associated with a specified outcome that is missing from the user's input to the Decision Making Platform 104. Continuing the health insurance coverage example, if the worker's data inputs did not include data relating to the number of hours worked during a pay period, the Decision Making Platform 104 may inform the user that if this information is available and/or if the information indicates that a threshold of hours are worked or exceeded per pay period then a necessary and sufficient fact pattern is present, yielding a certain or near certain expectation of the outcome of insurance coverage qualification (e.g., a 1.0, or near 1.0 probability of having insurance coverage).

In embodiments, the Decision Making Platform 104 may be used to evaluate the potential need, or lack thereof, for litigation, mediation, arbitration and the like between adverse parties, given a particular set of fact patterns claimed by the adverse parties. As described herein, the Decision Making Platform 104 may include a corpus of material containing fact patterns and decisions based on those fact patterns. These fact patterns may be evaluated using machine learning and other techniques, as described herein, to determine the degree of association between each fact pattern of the corpus and a plurality of specified outcomes of interest. Adverse parties often must evaluate the best course to take in order to resolve a dispute. Should the parties negotiate a settlement? Would it be best to litigate? Is mediation or arbitration a viable alternative? Part of this decision making process may involve fundamental questions of how strong of an argument one or both sides of the controversy have and/or the relative distance between the two positions taken by the parties. If, for example, the two parties' arguments and summary of the facts that are the subject of the dispute are relatively close together, and both sets of facts tend towards the same resolution (e.g., have similar degrees of association with a common outcome of interest), based on the historical fact patterns in evidence in the corpus associated with the Decision Making Platform 104, this may argue for the parties resolving their dispute without the added expense of litigation. Similarly, litigation may be viewed as impractical where the parties have vastly different sets of fact patterns and the Decision Making Platform 104 indicates a much stronger degree of association with the outcome of interest for one party. Conversely, if the two parties' factual summaries are vastly different and point to decidedly different outcomes, litigation might be the better course where a third party may evaluate the credibility of evidence and the like. In embodiments, the Decision Making Platform 104 may receive inputs from a user where the inputs describe and/or include at least one fact pattern, such as a fact pattern relating to a dispute, such as whether a certain type of damage to a home is covered by a home owner's insurance policy. The Decision Making Platform 104 may include a corpus of material relating to the underlying issue(s) associated with insurance policy laws, regulations, codes, procedures and the like. The Decision Making Platform 104 may determine through machine learning and other analytic processes, as described herein, the degree of association for each of the fact patterns in the corpus and specified outcomes of interest, such as when certain events are to be covered under an insurance policy type and when they are not. Continuing the example, the user's input may be evaluated in light of the information contained in the Decision Making Platform 104's corpus in order to determine a degree of association of the user's fact patterns within the input data and the specified outcome of interest (e.g., “event is covered by insurance”). Following this, a second set of data may be input to the Decision Making Platform 104, such as the insurance company's data relating to the event. This second set of data may differ from the first set of data input by the user. As with the first set of data inputs, the second set may be evaluated against the corpus in order to determine a degree of association of the second set of fact patterns within the second set of input data and the specified outcome of interest. The probability may be provided as a report and a conditional probability may be generated in which the full set of facts from the first and second sets of data inputs are considered together to evaluate the impact of all such fact patterns being present. For example, the insurance policy may include a provision that specifies that damage due to floods is to be a covered event if the water accumulated from the ground up, and exclude water damage resulting from falling rain, leaking roof, etc. If the first data input included a statement that there were 2 feet of water in the house that caused the damage to the walls, but the second data input stated that the 2 feet of water derived from an accumulation of water derived from a failing roof, then the conditional probability of the first user's data with the outcome of having the water damage covered by the insurance policy would be lowered by the presence of the second data's fact pattern showing that the water was not ground water, which the first data input omitted. The cumulative outcome of this analysis may be that there is a strong likelihood that, when presented with the insured's data and the insurance company's data, the probability of the insured's water damage being covered by the policy is low. This might not be the outcome that the insured wants, but having this information in advance may save the insured the time and expense of litigating for the insurance company to cover the damage.

In embodiments, the methods and systems of the Decision Making Platform 104 may be deployed on Amazon Web Services (AWS), or some other type of computer architecture:

The front end may use AngularJS;

The server side may use NodeJS;

Communication with the analytic engine 106 may be via RESTful services;

The Decision Making Platform 104 may be designed as a flexible architecture, where the backend is componentized in a way that allows switching backend providers (e.g., analytic engine 106) with relative ease.

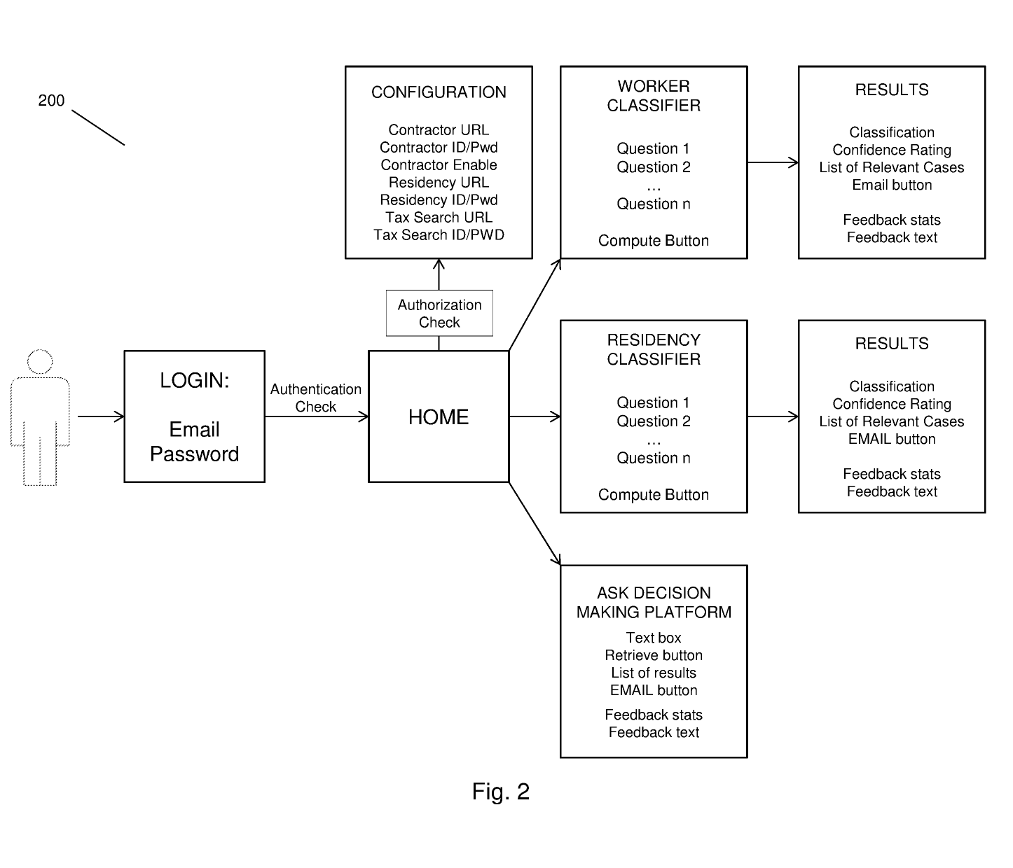

FIG. 2 illustrates one embodiment of a screen flow and analysis sequence of a user's interaction with the Decision Making Platform 104.

Following tables detail functional capabilities and non-limiting embodiments of the Decision Making Platform 104.
1.1.1 Login and User Management

| Req# | Functionality |
|---|---|
| 1.1 | The user may be able to log in using |
| | an email address and a password |
| | supplied to them. |
| 1.2 | The Decision Making Platform 104 |
| | may enable the creation of new users |
| | and removing existing users. |
| 1.3 | Users may be provided with a way to |
| | change a login email address. |
| 1.4 | Users may have a way to change a |
| | password. |

1.1.2 Ask Service

| Req# | Functionality |
|---|---|
| 2.1 | The site may have an Ask capability |
| | for posing questions to the Decision |
| | Making Platform 104. |
| 2.2 | The Ask capability may provide a |
| | text input field with a Search button. |
| 2.3 | A user may enter any text of their |
| | choosing into the text input field. |
| 2.4 | When a user presses the ‘Ask’ button |
| | (or presses Enter) the text may be |
| | submitted to the analytic engine 106 |
| | “Retrieve and Rank” and a list of, for |
| | example, the 5 highest rated |
| | responses may be displayed to the |
| | user. |
| 2.5 | When the results are presented there |
| | may be an ‘Email Me’ button that |
| | sends the results to a user's email |
| | address. |
| 2.6 | When the results are presented |
| | optional feedback ratings may be |
| | shown for the user to enter, including |
| | but not limited to: |
| | Speed |
| | Accuracy |
| | Relevance of Supporting |
| | Evidence |
| 2.7 | If a feedback rating is less than, for |
| | example, 5 stars, a feedback textbox |
| | and submit button may be presented, |
| | asking the user what the Decision |
| | Making Platform 104 could have |
| | done better. |
| 2.8 | When the top 5 results are displayed, |
| | there may also be a ‘See More’ |
| | button to display additional results. |
| 2.9 | When the user submits feedback it |
| | may be emailed to the Decision |
| | Making Platform 104 and other |
| | relevant reviewers. |
| 2.10 | When results are first shown to the |
| | user the Decision Making Platform |
| | 104 may log those results in the |
| | database. |
| 2.11 | When a user submits feedback, the |
| | Decision Making Platform 104 may |
| | append that feedback to the existing |
| | log record in the database. |

1.1.3 Worker Classification Service

| Req# | Functionality |
|---|---|
| 3.1 | The site associated with the Decision |
| | Making Platform 104 may have a |
| | Worker Classifier capability. |
| 3.2 | The Worker Classifier screen may |
| | provide a user with a list of static |
| | questions (answered by checkbox |
| | and free text). |
| 3.3 | When a user answers a question, the |
| | request may be immediately sent to |
| | the analytic engine 106 and the |
| | response cached. |
| 3.4 | When a user presses submit, a single |
| | classification determination may be |
| | displayed (Independent Contractor or |
| | Employee) along with a confidence |
| | rating (percentage). |
| 3.5 | When a user presses submit, a list of, |
| | for example, the top 5 relevant cases |
| | are displayed to the user. |
| 3.6 | When a user hits submit, a visual |
| | ‘processing’ indicator may be |
| | displayed. |
| 3.7 | If the response from the analytic |
| | engine 106 is complete in less than, |
| | for example, 2 seconds, the |
| | ‘processing’ indicator may continue |
| | to display for the full 2 seconds |
| | before the results are displayed. |
| 3.8 | For every question the user may have |
| | the option to either not answer or to |
| | answer ‘Don't know’. |
| 3.9 | When the results are presented the |
| | Decision Making Platform 104 may |
| | also have optional feedback ratings |
| | for the user to enter, including but |
| | not limited to: |
| | Speed |
| | Accuracy |
| | Relevance of Supporting |
| | Evidence |
| 3.10 | If any feedback rating is less than, |
| | for example, 5 stars a feedback |
| | textbox and submit button may be |
| | presented, asking the user what the |
| | Decision Making Platform 104 could |
| | have done better. |
| 3.11 | When the user submits feedback it |
| | may be emailed to the Decision |
| | Making Platform 104 and other |
| | relevant reviewers. |
| 3.12 | When the results are presented there |
| | may be an ‘Email Me’ button that |
| | sends the results to the user's email |
| | address. |
| 3.13 | When results are first shown to the |
| | user the Decision Making Platform |
| | 104 may log those results in the |
| | database. |
| 3.14 | When a user submits feedback, the |
| | Decision Making Platform 104 may |
| | append that feedback to the existing |
| | log record in the database. |

1.1.4 Residency Classification Service

| Req# | Functionality |
|---|---|
| 4.1 | The site may have a Residency |
| | Classifier capability. |
| 4.2 | The Residency Classifier screen may |
| | provide a user with a list of static |
| | questions (answered by checkbox |
| | and free text). |
| 4.3 | When a user answers a question, the |
| | request may be sent to the analytic |
| | engine 106 and the response cached. |
| 4.4 | When a user presses submit, a single |
| | classification determination may be |
| | displayed (Resident or Non- |
| | Resident) along with a confidence |
| | rating (percentage). |
| 4.5 | When a user presses submit, a list of, |
| | for example, the top 5 relevant cases |
| | may be displayed to the user. |
| 4.6 | When a user hits submit, a visual |
| | ‘processing’ indicator may be |
| | displayed. |
| 4.7 | If the response from the analytic |
| | engine 106 is complete in less than, |
| | for example, 2 seconds, the |
| | ‘processing’ indicator may continue |
| | to display for the full 2 seconds |
| | before the results are displayed. |
| 4.8 | For every question, a user may have |
| | the option to either not answer or to |
| | answer ‘Don't know’. |
| 4.9 | When the results are presented the |
| | Decision Making Platform 104 may |
| | also have optional feedback ratings |
| | for the user to enter, including but |
| | not limited to: |
| | Speed |
| | Accuracy |
| | Relevance of Supporting |
| | Evidence |
| 4.10 | If any feedback rating is less than, |
| | for example, 5 stars, a feedback |
| | textbox and submit button may be |
| | presented, asking the user what the |
| | Decision Making Platform 104 could |
| | have done better. |
| 4.11 | When the user submits feedback it |
| | may be emailed to the Decision |
| | Making Platform 104 and other |
| | relevant reviewers. |
| 4.12 | When the results are presented there |
| | may be an ‘Email Me’ button that |
| | sends the results to the user's email |
| | address. |
| 4.13 | When results are first shown to the |
| | user, the Decision Making Platform |
| | 104 may log those results in the |
| | database. |
| 4.14 | When a user submits feedback, the |
| | Decision Making Platform 104 may |
| | append that feedback to the existing |
| | log record in the database. |

1.1.5 Configuration Page

| Req# | Functionality |
|---|---|
| 5.1 | The site may have a configuration |
| | page. |
| 5.2 | The configuration page may only |
| | accessible by authorized |
| | administrative users. |
| 5.3 | The configuration page may allow a |
| | user to change the URL for the |
| | analytic engine 106 instances being |
| | used. |
| 5.4 | The configuration page may allow |
| | the user to change the username and |
| | password for the analytic engine 106 |
| | instances being used. |
| 5.5 | The configuration pages may allow |
| | the user to enable and disable any of |
| | the services. |

1.1.6 Additional Functional Requirements

| Req# | Functionality |
|---|---|
| 6.1 | If a user navigates away from a |
| | particular service and back to that |
| | service, there may be no requirement |
| | to save state, the user may start |
| | again. |
| 6.2 | A standard user may not see disabled |
| | services. |
| 6.3 | An administrative user may see all |
| | services (including disabled |
| | services). |

In embodiments, the Decision Making Platform 104 may support the browsers, including but not limited to:

Internet Explorer

Safari

Chrome

Firefox

Mobile browsers, including but not limited to Android, Firefox for mobile, Amazon Silk, Chrome, Internet Explorer Mobile, Blazer, Kindle, Iris, or some other type of browser

In embodiments, the Decision Making Platform 104 may support a plurality of users utilizing the Decision Making Platform 104 simultaneously.

In embodiments, the Decision Making Platform 104 may require no additional monitoring on top of what is provided by default from, for example, AWS.

In embodiments, the Decision Making Platform 104 may require no additional alarming on top of what is provided by default from, for example, AWS.

In embodiments, the Decision Making Platform 104 may include a maintenance capability in the form of a configuration page that allows an administrator and/or users to reconfigure which analytic engine 106 instances the site uses.

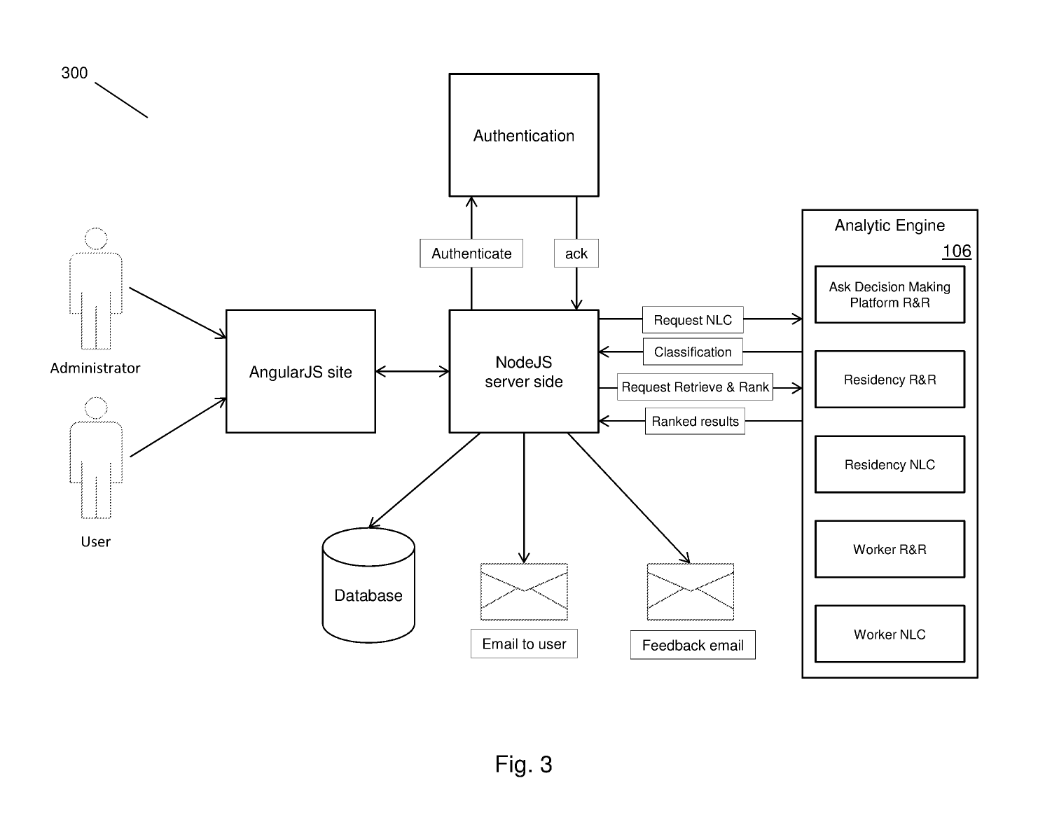

FIG. 3 illustrates a high-level component/integration model, with the corresponding descriptions of example, non-limiting embodiments provided in the table below, showing a login and authentication process that may be conducted within the Decision Making Platform 104 or in association with the Decision Making Platform 104. As used in FIG. 3, “R&R” refers to retrieving rank, and “NLC” refers to natural language classifier.

| Component | Description |
|---|---|
| AngularJS site | Front end written in AngularJS. |
| NodeJS | Server side written using NodeJS |
| server side | |
| Authentication | Authentication component facilitating |
| | basic login capability. May use |
| | Stormpath or a similar service. |
| Database | Database (e.g., Mongo or MySQL) that holds |
| | configuration data for |
| | analytic engine 106 instances, as well as |
| | log data for requests (whether |
| | feedback is provided or not). |
| Analytic | External system. May invoke RESTful services |
| engine 106 | (e.g., the Natural Language Classification |
| | and Retrieve & Rank services) |
| | to connect to the Platform's instances as |
| | shown in FIG. 3. The analytic engine 106 may |
| | provide a NodeJS adapter for easy |
| | invocation of their services. |
| Email | When a user gets classification results, |
| to User | they may have the option to |
| | email themselves a copy of those results. |
| Feedback | Whenever a user submits feedback, that |
| Email | feedback may be emailed to a |
| | Decision Making Platform 104 email |
| | address for potential action. |

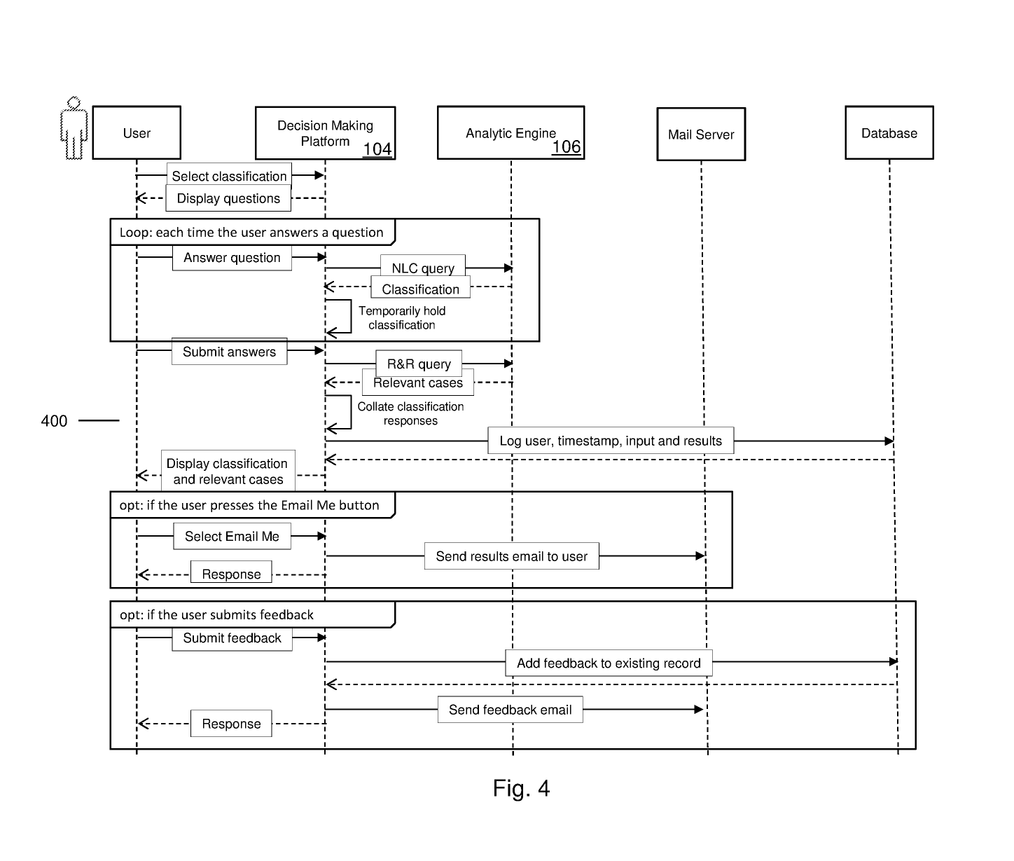

The diagram provided in FIG. 4 describes a hypothetical (Worker and Residency) question flow.
1. A user may select a classification service (e.g., worker or residency) and be presented with a list of questions pertaining to that service.
2. The user may start by answering questions. As the user answers each question, a request may be sent to the analytic engine 106 to retrieve the classification and confidence rating for that question. This information may be held internally until all the answers have been provided. This approach may reduce response time when the user finally submits (but this may not be required by the Platform).
3. The user may select a button to submit all of their answers. A request may be sent to the Retrieve and Rank service to bring back a list of relevant cases. The previously retrieved classification and confidence scores may be collated and averaged (with relevant weightings) to provide a single classification and confidence score.
4. The user, timestamp, input questions and answers and outputs may be logged in the database.
5. The classification, confidence percentage and relevant cases may then be displayed to the user.
6. The user may optionally click on an ‘Email Me’ button which sends an email to the user's email address including the input questions and answers, and the results (classification, confidence rating, relevant cases).
7. The user may optionally fill in a number of feedback star ratings. If any of those star ratings are under, for example, 5 stars, they have the option of sending some textual feedback. If they submit feedback, an email may be sent to the Decision Making Platform 104 including the user's email address, the input questions and answers, the results (classification, confidence rating, relevant cases), the feedback ratings, and the feedback text.
8. Feedback data may be appended to the existing database record for this interaction.

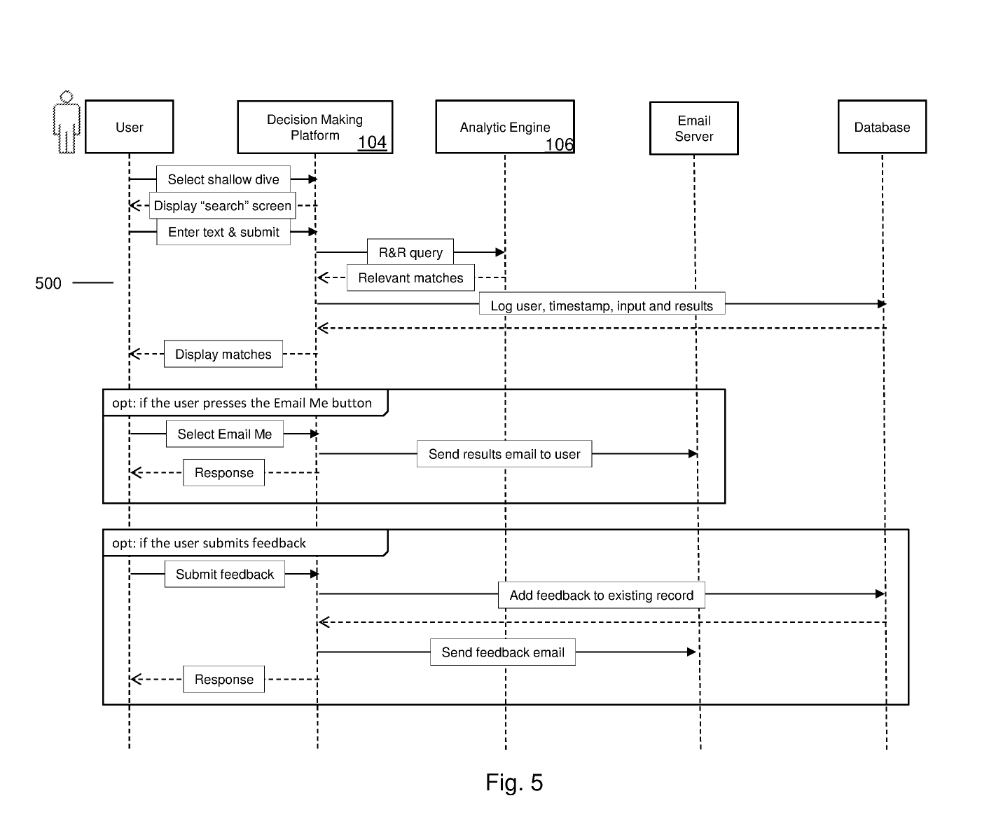

The diagram provided in FIG. 5 describes a hypothetical “Ask” question service flow.
1. A user may select the Ask question service and be presented with a screen that contains a single free form text box along with an ‘Ask’ button.
2. The user may enter text and press the ‘Ask’ button. The text may be submitted to the appropriate Retrieve and Rank service which returns a number of ranked matches.
3. The user, timestamp, input text and outputs may be logged in the database.
4. The matches, for example the first 5 matches, may then be displayed to the user on the same screen.
5. The user may optionally click on an ‘Email Me’ button which sends an email to the user's email address including the input question, and the top results.
6. The user may optionally fill in feedback star ratings. If any of those star ratings are under, for example 5 stars, they may have the option of sending some textual feedback. If they submit feedback, an email may be sent to the Decision Making Platform 104 including the user's email address, the input text, the results (e.g., the 5 highest matches), the feedback ratings, and the feedback text.
7. Feedback data may be appended to the existing database record for this interaction.

Certain operations are described herein as responding to a detected change in a degree of association of user fact patterns to an outcome of interest, and/or detected changes in a probably outcome of interest. A detected change as utilized herein should be understood broadly. A detected change may be qualitative and/or quantitative. For example, and without limitation, a detected change includes a change in an estimated outcome probability, a change in a confidence value and/or estimate of statistical significance value for an estimated outcome, a change in one or more data inputs, a change in one or more selected data inputs from a group of data inputs, a change in one or more user inputs, a change in one or more selected user inputs from a group of user inputs, a change in one or more inputs for users similarly positioned to a specific user, a change in an outcome category (e.g. insurance applicability or availability, health care coverage availability, change in a tax filing requirement, and/or a change in a dispute resolution recommendation), and/or a change in an estimated outcome quantity (e.g. an estimated cost value, savings value, recommendation value such as hours worked, coverage needed, and/or a quantity of money or securities to be moved, divested, and/or purchased). Certain operations are described herein as responsive to threshold values of the detected change. Example and non-limiting threshold values for a detected change include, without limitation, a selected amount of change in a quantitative output value, a change in a selected qualitative output value and/or outcome category, and/or a change in an input value of a selected type (e.g. a change in a necessary input value, a change in an input value from “not necessary” to “necessary” based on other changes (e.g. a regulatory change), and/or a change in an input value from “necessary” to “not necessary”. Example thresholds for a quantitative output value include a change in a probability outcome, such as an increase or decrease in a probability by a selected amount (e.g. change greater than 0.05, 0.10, 0.20, 0.30, 0.40, 0.50), an increase or decrease in a probability to a selected absolute threshold value (e.g. lower than 0.25, 0.20, 0.15, 0.10, 0.05, 0.01; and/or greater than 0.75, 0.80, 0.85, 0.90, 0.95, 0.99). In certain embodiments, a quantitative output value threshold includes an underlying quantity value change, such as a dollar value threshold, and/or an activity quantity threshold (e.g. a change in working hours greater than a threshold value, a change in quantity of money or securities to be acquired, divested, moved, etc.)

The determination of a threshold value includes operations to accept user input for a threshold (e.g. user inputs thresholds directly, inputs a risk tolerance input from which a threshold value is determined, and/or flags categories of inputs or outcomes to watch for changes), operations to determine a threshold value in response to one or more aspects of a user (e.g. select thresholds from values used for similarly positioned users, and/or according to one or more user characteristics), and/or utilization of default values. In certain embodiments, a threshold value may be adjusted in response to external characteristics such as an updating in an importance of an input value and/or an outcome value (e.g. a change in an input from “necessary” to “not necessary” or the reverse, a change in an underlying regulation or other aspect of the outcome estimating algorithm operated by a Decision Making Platform 104, and/or an amount of time that has elapsed since a change in the outcome of interest has been determined to meet a detection change threshold).

One of skill in the art, having the benefit of the disclosures herein and information readily available when contemplating a particular embodiment, can readily determine appropriate detected changes and threshold values for detected changes. Certain considerations to determine appropriate detected changes and threshold values include, without limitation: the nature of the outcome of interest (e.g. criticality, severity of incorrect decisions, informative versus decision-driving, response time requirements for the types of decisions involved in the outcome, typical rates of change for the nature of the outcome); a sensitivity value for the outcome of interest (e.g. an outcome that has a high change in practical outcome for the user based on a small change in the outcome value determined by the estimated outcome); an uncertainty value for the outcome of interest (e.g. higher confidence estimates, in certain embodiments, may drive a higher threshold value relative to a low confidence estimate for outcomes of interest having an otherwise similar nature); a rate of change value of data inputs; a risk tolerance value indicated, exhibited, evident, or updated in the user inputs by the user; a risk tolerance value indicated, exhibited, evident, or updated in the user inputs of similarly positioned users to the user; an interest value indicated exhibited, evident, or updated in the user inputs by the user for selected data inputs and/or outcomes; and/or an interest value indicated, exhibited, evident, or updated in user inputs of similarly positioned users to the user.

The following are illustrative clauses demonstrating non-limiting embodiments of the disclosure described herein:

A method comprising:
defining an outcome of interest;
receiving a plurality of inputs;
analyzing the plurality of inputs to determine a plurality of fact patterns that are associated with the outcome of interest;
calculating a degree of association between each of the plurality of fact patterns to the outcome of interest;
receiving a user input, wherein the user input is provided through a graphical user interface that is associated with a remote client device;
analyzing the user input to determine a plurality of user fact patterns;
comparing the user fact patterns with the plurality of fact patterns; and
presenting a report to the user on the remote client device, wherein the report includes at least in part a summary of the degree of association of the user fact patterns with the outcome of interest based on the comparison of the user fact patterns with the plurality of fact patterns.

The method as claimed in the preceding claim, wherein the summary is ranked based at least in part on the strength of the degree of association.

The method as claimed in any one of the preceding claims, wherein the user is a plurality of users

The method as claimed in any one of the preceding claims, wherein the plurality of users' inputs is analyzed in the aggregate

A method comprising:
defining an outcome of interest;
receiving a plurality of inputs;
analyzing the plurality of inputs to determine a first plurality of fact patterns that are associated with the outcome of interest;
calculating a degree of association between each of the first plurality of fact patterns to the outcome of interest;
receiving a user input, wherein the user input is received through a graphical user interface that is associated with a remote client device;
analyzing the user input to determine a plurality of user fact patterns;
comparing the user fact patterns with the first plurality of fact patterns;
receiving a new input;
incorporating the new input into the plurality of inputs to create an updated plurality of input;
analyzing the updated plurality of inputs to determine a second plurality of fact patterns that are associated with the outcome of interest;
calculating a second degree of association between each of the second plurality of fact patterns to the outcome of interest;
comparing each user fact pattern among the plurality of user fact patterns with the second plurality of fact patterns;
detecting a change in a degree of association of at least one of the user fact patterns based on the degree of association with the second plurality of fact patterns relative to the degree of association with the first plurality of fact patterns; and
presenting a report to the user on the remote client device, wherein the report includes at least in part a summary of the detected change in the degree of association of the user fact patterns to the outcome of interest.

The method as claimed in any one of the preceding claims, wherein the report is generated in response to the detected change meeting or exceeding a threshold level of change specified by the user.

The method as claimed in any one of the preceding claims, wherein the report is generated in response to the detected change meeting or exceeding a threshold level of change that is statistically significant.

The method as claimed in any one of the preceding claims, wherein the report is generated in response to the detected change meeting or exceeding a threshold level of change that alters the probable outcome of interest relative to that determine in a prior report for the user.

The method as claimed in any one of the preceding claims, wherein the presentation of the report is associated with an alert that is sent to the user's remote client device.

The method as claimed in any one of the preceding claims, wherein the alert is transmitted over a communication channel to the remote client device associated with the user based upon a destination address and transmission schedule that is associated with the remote client device.

The method as claimed in any one of the preceding claims, wherein the alert activates the graphical user interface to cause the alert to display on the remote client device and to enable connection with the graphical user interface when the remote client device is activated.

The method as claimed in any one of the preceding claims, wherein the input comprises text.

The method as claimed in any one of the preceding claims, wherein the input text comprises a court decision.

The method as claimed in any one of the preceding claims, wherein the input text comprises an administrative decision.

The method as claimed in any one of the preceding claims, wherein the input text comprises regulatory guidance.

The method as claimed in any one of the preceding claims, wherein the input text comprises a regulation.

The method as claimed in any one of the preceding claims, wherein the input text comprises a law.

The method as claimed in any one of the preceding claims, wherein the input text comprises a news release.

The method as claimed in any one of the preceding claims, wherein the input text comprises a professional white paper.

The method as claimed in any one of the preceding claims, wherein the input text comprises a journal article.

The method as claimed in any one of the preceding claims, wherein the input text comprises an RSS feed.

The method as claimed in any one of the preceding claims, wherein the input text derives from webcrawling.

The method as claimed in any one of the preceding claims, wherein the input text derives from a third party database.

The method as claimed in any one of the preceding claims, wherein the input comprises audio.

The method as claimed in any one of the preceding claims, wherein the analysis of the plurality of input is based at least in part on semantic analysis.

The method as claimed in any one of the preceding claims, wherein the outcome of interest comprises a categorization.

The method as claimed in any one of the preceding claims, wherein the categorization relates to a taxation criterion.

The method as claimed in any one of the preceding claims, wherein the degree of association comprises a numeric probability.

The method as claimed in any one of the preceding claims, wherein the numeric probability is a conditional probability.

The method as claimed in any one of the preceding claims, wherein the conditional probability is conditional on the entirety of a plurality of fact patterns and/or a subset of a plurality of fact patterns.

The method as claimed in any one of the preceding claims, wherein the analysis of the plurality of input is based at least in part on voice recognition

The method as claimed in any one of the preceding claims, wherein the degree of association is a binary categorization.

The method as claimed in any one of the preceding claims, wherein the degree of association is a plurality of categories.

The method as claimed in any one of the preceding claims, wherein the user comprises a plurality of users.

The method as claimed in any one of the preceding claims, wherein the plurality of users' inputs is analyzed in the aggregate.

A method comprising:
defining an outcome of interest;
receiving a plurality of inputs;
analyzing the plurality of inputs to determine a plurality of fact patterns that are associated with the outcome of interest;
calculating a degree of association between each of the plurality of fact patterns to the outcome of interest;
ranking each fact pattern among the plurality of fact patterns according to the degree of association; and
presenting a ranked report to a user on a remote client device, wherein the report includes at least in part a subset of the plurality of fact patterns bearing the strongest degree of association with the outcome of interest.

The method as claimed in any one of the preceding claims, wherein the presented ranked report identifies at least one fact pattern among the plurality of fact patterns that is necessary to maintain a degree of association with the outcome of interest above a specified threshold, and which is missing from a user's set of fact patterns.

The method as claimed in any one of the preceding claims, wherein the specified threshold is specified by the user.

The method as claimed in any one of the preceding claims, wherein the specified threshold is specified by a level of statistical significance.

The method as claimed in any one of the preceding claims, wherein the presented ranked report identifies at least one fact pattern among the fact pattern that is necessary to maintain a degree of association with the outcome of interest above a specified threshold, and which is missing from a user's set of fact patterns.

The method as claimed in any one of the preceding claims, wherein the presented ranked report identifies at least one combination of fact patterns among the fact pattern that is necessary to maintain a degree of association with the outcome of interest above a specified threshold.

The method as claimed in any one of the preceding claims, wherein the presented ranked report identifies at least one fact pattern among the fact pattern that is necessary to maintain a degree of association with the outcome of interest above a specified threshold.

A method comprising:
defining an outcome of interest;
receiving a plurality of inputs;
analyzing the plurality of inputs to determine a plurality of fact patterns that are associated with the outcome of interest;
calculating a degree of association between each of the plurality of fact patterns to the outcome of interest;
receiving a first user input, wherein the first user input is provided through a graphical user interface that is associated with a remote client device;
analyzing the first user input to determine a plurality of first user fact patterns;
calculating a probability of the first user fact pattern yielding the outcome of interest based at least in part on a comparison with the plurality of fact patterns;
   receiving a second user input;
analyzing the second user input to determine a plurality of second user fact patterns;
calculating a conditional probability of the first user fact pattern yielding the outcome of interest based at least in part on a comparison with the plurality of fact patterns and comparison with the second user fact patterns; and
presenting a report to the user on the remote client device, wherein the report includes at least in part the conditional probability.

The method as claimed in any one of the preceding claims, wherein the first remote client device and the second remote client device are a common remote client device.

A method comprising:
defining an outcome of interest;
receiving a plurality of input;
analyzing the plurality of input to determine a plurality of fact patterns that are associated with the outcome of interest;
calculating a degree of association between each of the plurality of fact patterns to the outcome of interest;
receiving a first user input, wherein the first user input is provided through a graphical user interface that is associated with a first remote client device;
analyzing the first user input to determine a plurality of first user fact patterns;
calculating a first probability of the first user fact pattern yielding the outcome of interest based at least in part on a comparison with the plurality of fact patterns;
receiving a second user input, wherein the first user input is provided through a graphical user interface that is associated with a second remote client device;
analyzing the second user input to determine a plurality of second user fact patterns;
calculating a second probability of the second user fact pattern yielding the outcome of interest based at least in part on a comparison with the plurality of fact patterns;
calculating a divergence measure, wherein the divergence measure expresses the degree of separation between the first probability and the second probability; and
presenting a report to at least one user, wherein the report includes at least in part the divergence measure.

The method as claimed in any one of the preceding claims, wherein the first remote client device and the second remote client device are a common remote client device.

The methods and systems described herein may be deployed in part or in whole through a machine that executes computer software, program codes, and/or instructions on a processor. References to a “processor,” “processing unit,” “processing facility,” “microprocessor,” “co-processor” or the like are meant to also encompass more that one of such items being used together. The present disclosure may be implemented as a method on the machine, as a system or apparatus as part of or in relation to the machine, or as a computer program product embodied in a computer readable medium executing on one or more of the machines. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be or include a frequency division multiple access (FDMA) network or a code division multiple access (CDMA) network. The cellular network may include mobile devices, cell sites, base stations, repeaters, antennas, towers, and the like. The cell network may be one or more of GSM, GPRS, 3G, EVDO, mesh, or other network types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

All documents referenced herein are hereby incorporated by reference.

What is claimed is:

1. A method comprising:
defining an outcome of interest;
receiving a plurality of inputs;
analyzing the plurality of inputs to determine a first plurality of fact patterns that are associated with the outcome of interest;
calculating a degree of association between each of the first plurality of fact patterns to the outcome of interest;
receiving a user input, wherein the user input is received through a graphical user interface that is associated with a remote client device;
analyzing the user input to determine a plurality of user fact patterns;
comparing the user fact patterns with the first plurality of fact patterns;
receiving a new input;
incorporating the new input into the plurality of input to create an updated plurality of input;
analyzing the updated plurality of input to determine a second plurality of fact patterns that are associated with the outcome of interest;
calculating a second degree of association between each of the second plurality of fact patterns to the outcome of interest;
comparing each user fact pattern among the plurality of user fact patterns with the second plurality of fact patterns;
detecting a change in a degree of association of at least one of the user fact patterns based on the degree of association with the second plurality of fact patterns relative to the degree of association with the first plurality of fact patterns; and
presenting a report to a user on the remote client device, wherein the report includes a summary of the detected change in the degree of association of the user fact patterns to the outcome of interest.

2. Further comprising the method of claim 1, wherein the report is generated in response to the detected change meeting or exceeding a threshold level of change specified by the user.

3. Further comprising the method of claim 1, wherein the report is generated in response to the detected change meeting or exceeding a threshold level of change that is statistically significant.

4. Further comprising the method of claim 1, wherein the report is generated in response to the detected change meeting or exceeding a threshold level of change that alters the probable outcome of interest relative to that determined in a prior report for the user.

5. The method of claim 1, wherein the presentation of the report is associated with an alert that is sent to the user's remote client device.

6. The method of claim 1, wherein the alert is transmitted over a communication channel to the remote client device associated with the user based upon a destination address and transmission schedule that is associated with the remote client device.

7. The method of claim 1, wherein the alert activates the graphical user interface to cause the alert to display on the remote client device and to enable connection with the graphical user interface when the remote client device is activated.

8. The method of claim 1, wherein the input comprises text.

9. The method of claim 8, wherein the input text comprises a court decision.

10. The method of claim 8, wherein the input text comprises an administrative decision.

11. The method of claim 8, wherein the input text comprises regulatory guidance.

12. The method of claim 1, wherein the input comprises audio input.

13. The method of claim 1, wherein the analysis of the plurality of input is based at least in part on semantic analysis.

14. The method of claim 1, wherein the outcome of interest comprises a categorization.

15. The method of claim 1, wherein the degree of association comprises a numeric probability.

16. The method of claim 15, wherein the numeric probability comprises a conditional probability.

17. The method of claim 1, wherein the user comprises a plurality of users.

18. A method comprising:
defining an outcome of interest;
receiving a plurality of inputs;
analyzing the plurality of inputs to determine a plurality of fact patterns that are associated with the outcome of interest;
calculating a degree of association between each of the plurality of fact patterns to the outcome of interest;
ranking each fact pattern among the plurality of fact patterns according to the degree of association; and
presenting a ranked report to a user on a remote client device, wherein the report includes at least in part a subset of the plurality of fact patterns bearing the strongest degree of association with the outcome of interest.

19. The method of claim 18, wherein the presented ranked report identifies at least one fact pattern among the plurality of fact patterns that is necessary to maintain a degree of association with the outcome of interest above a specified threshold, and which is missing from a user's set of fact patterns.

20. A method comprising:
defining an outcome of interest;
receiving a plurality of inputs;
analyzing the plurality of inputs to determine a plurality of fact patterns that are associated with the outcome of interest;
calculating a degree of association between each of the plurality of fact patterns to the outcome of interest;
receiving a first user input, wherein the first user input is provided through a graphical user interface that is associated with a remote client device;
analyzing the first user input to determine a plurality of first user fact patterns;
calculating a probability of the first user fact pattern yielding the outcome of interest based at least in part on a comparison with the plurality of fact patterns;
receiving a second user input;
analyzing the second user input to determine a plurality of second user fact patterns;
calculating a conditional probability of the first user fact pattern yielding the outcome of interest based at least in part on a comparison with the plurality of fact patterns and comparison with the second user fact patterns; and
presenting a report to the user on the remote client device, wherein the report includes at least in part the conditional probability.
